(19) United States
(12) Patent Application Publication
(10) Pub. No.: US 2019/0340634 A1
(43) Pub. Date: Nov. 7, 2019

(54) SYSTEMS AND METHOD FOR INCENTIVIZING FEEDBACK ON SOCIAL MEDIA

(71) Applicant: ServiceNow, Inc., Santa Clara, CA (US)

(72) Inventors: Sarup Paul, Pleasanton, CA (US); Harish Kumar Balachandra Bellamane, San Jose, CA (US); Sanjay Kumar Gupta, Saratoga, CA (US)

(21) Appl. No.: 15/970,650

(22) Filed: May 3, 2018

(51) Int. Cl. G06Q 30/02; G06Q 50/00

(52) U.S. Cl. CPC G06Q 30/0217; G06Q 50/01

(57) ABSTRACT

The present approach is related to incentivizing users of social media to provide feedback for certain products. The embodiments include monitoring relevant social media content that includes feedback associated with the products, where the social media content is created by different users via social media profiles. Evaluation rules are applied to the social media content to allocate a number points to the social media profiles every time relevant social media is created. When a certain threshold of accumulated points has been exceeded by a user, the user is further incentivized to continue to provide feedback to products via social media, where the incentive includes a form of a reward.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A modern aspect of electronic commerce and communications is that individuals may comment or provide feedback with respect to a product in an online media channel. Such feedback enables others to know more about such products and gives the product supplier an idea of consumer sentiments of the products, which may potentially be used for improvements. Increasingly, social media has become a popular resource for both companies and consumers alike to publicize and comment on products. Consumers may create social media content that includes product feedback, which may be viewed by other users of the social media. The viewers of such social media content may then be influenced in terms of their opinions or purchase patterns with respect to a given product.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

This disclosure generally relates to incentivizing social media users (also referred to as a “user” or “users” herein) that create social media content providing feedback (e.g., positive feedback or comments) regarding a monitored product. Specifically, social media content created by different user profiles may be monitored and/or aggregated, such as using a social media aggregation platform. If a user profile's social media content mentions a monitored product, the social media content may be determined to be relevant and information related to the social media content may be saved. The social media content may then be evaluated, such as using rule-based or machine learning heuristics, to determine if any evaluation rules apply. In some embodiments, the evaluation rules award a certain number of based on the social media content, such as based on the social media content subject matter and/or based on the user profile's social media information. Such points may then be allocated to the user profile or to some other identifier of the user generating the content. As the user profile continues to provide feedback on the product in question (or on other monitored products), the user profile or identifier accumulates points as determined by the evaluation rules. Based on one or more threshold criteria, the user profile may receive a reward based on the accumulation of points. This reward may incentivize the user profile to continue providing feedback regarding the monitored product(s) via social media to receive additional rewards. In some embodiments, receiving the reward is awarded on or via the social media platform (such as a code to redeem for additional products, discounts, new products to try and so forth) such that other users of the social medial platform are aware of the reward and may in turn be incentivized to provide feedback.

Various refinements of the features noted above may exist in relation to aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud computing system in which embodiments of the present disclosure may operate;

FIG. 2 is a block diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram of an embodiment of a system to incentivize social media users to provide feedback via social media, in accordance with an embodiment of the present disclosure;

FIG. 5 is a block diagram of an embodiment of integrating social media content into a monitoring platform, in accordance with an embodiment of the present disclosure; and

FIG. 6 is a flowchart of an embodiment of a method to incentivize providing feedback via social media, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

Social media is prevalent as a way of communication between users of the various social media platforms. Most social media platforms, such as FACEBOOK®, TWITTER®, and INSTAGRAM®, provide the opportunity for individuals to share information. The information may be shared locally (e.g., among friends) or publically and information may thereby spread at a rapid pace. As a result, many organizations find that social media platforms are an efficient method of publicizing products and communicating such products in an effort to increase sales. For example, organizations may use social media to receive feedback on their products, where the feedback is provided by consumers who have purchased their products. The feedback may include a consumer's sentiments regarding the product and may include reasons to why the consumer is providing such sentiments. Different consumers may each provide feedback on a product and thus, feedback associated with the product accumulates. The accumulated feedback gives the consumer community an image of the product, which may influence other consumers whether or not to purchase the product.

It is beneficial for organizations to receive positive feedback via social media platforms for their products as such feedback may encourage others to purchase their products. However, consumers may not be highly incentivized to take the time to provide feedback. Indeed, consumers who are satisfied with their product may not feel it worth their time to provide feedback if the product is already performing to their satisfaction. As such, it may be difficult for products, especially new products, to be positively publicized in a short amount of time. As a result, it is presently recognized that a system that incentivizes consumers to provide feedback on social media would quickly increase product and potentially brand awareness for an organization.

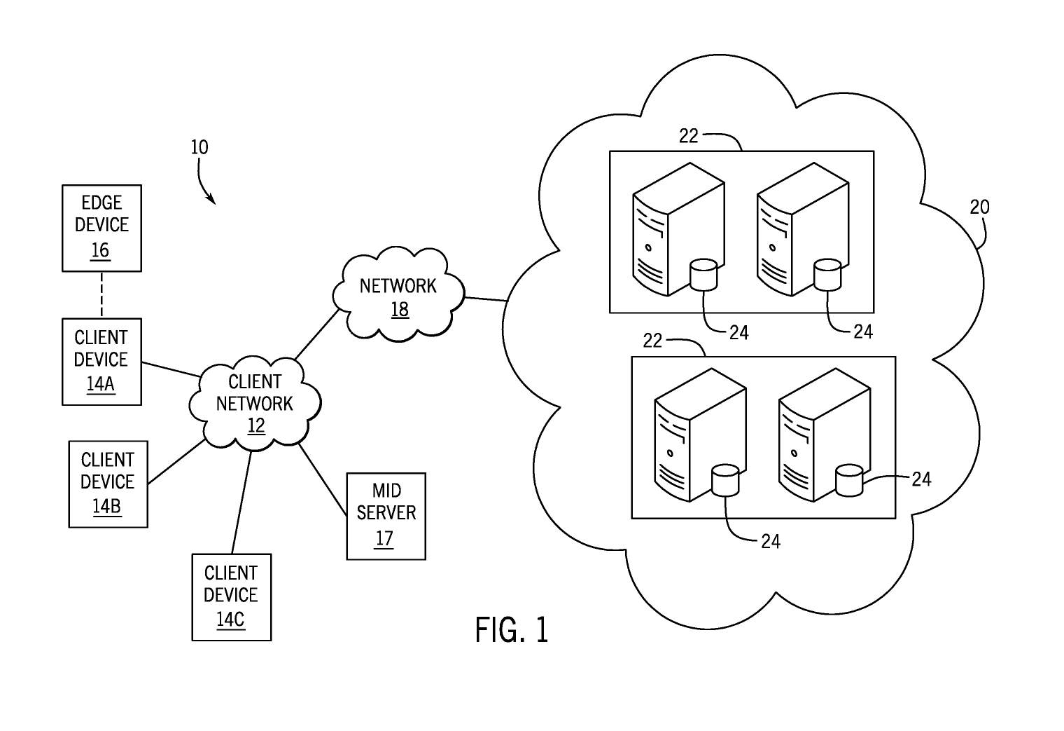

With the preceding in mind, the following figures relate to various types of generalized system architectures or configurations that may be employed to provide services to an organization in a multi-instance framework on which the present approaches may be employed. Correspondingly, these system and platform examples may also relate to systems and platforms on which the techniques discussed herein may be implemented or otherwise utilized. Turning now to FIG. 1, a schematic diagram of an embodiment of a computing system 10, such as a cloud computing system, where embodiments of the present disclosure may operate, is illustrated. Computing system 10 may include a client network 12, network 18 (e.g., the Internet), and a cloud-based platform 20. In some implementations, the cloud-based platform may be a configuration management database (CMDB) platform. In one embodiment, the client network 12 may be a local private network, such as local area network (LAN) that includes a variety of network devices that include, but are not limited to, switches, servers, and routers. In another embodiment, the client network 12 represents an enterprise network that could include one or more LANs, virtual networks, data centers 22, and/or other remote networks. As shown in FIG. 1, the client network 12 is able to connect to one or more client devices 14A, 14B, and 14C so that the client devices are able to communicate with each other and/or with the network hosting the platform 20. The client devices 14A-C may be computing systems and/or other types of computing devices generally referred to as Internet of Things (IoT) devices that access cloud computing services, for example, via a web browser application or via an edge device 16 that may act as a gateway between the client devices and the platform 20. FIG. 1 also illustrates that the client network 12 includes a bridge device or server, such as a management, instrumentation, and discovery (MID) server 17 that facilitates communication of data between the network hosting the platform 20, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 18. The network 18 may include one or more computing networks, such as other LANs, wide area networks (WAN), the Internet, and/or other remote networks, in order to transfer data between the client devices 14A-C and the network hosting the platform 20. Each of the computing networks within network 18 may contain wired and/or wireless programmable devices that operate in the electrical and/or optical domain. For example, network 18 may include wireless networks, such as cellular networks (e.g., Global System for Mobile Communications (GSM) based cellular network), WiFi® networks (WIFI is a registered trademark owned by Wi-Fi Alliance Corporation), and/or other suitable radio-based networks. The network 18 may also employ any number of network communication protocols, such as Transmission Control Protocol (TCP) and Internet Protocol (IP). Although not explicitly shown in FIG. 1, network 18 may include a variety of network devices, such as servers, routers, network switches, and/or other network hardware devices configured to transport data over the network 18.

In FIG. 1, the network hosting the platform 20 may be a remote network (e.g., a cloud network) that is able to communicate with the client devices 14A-C via the client network 12 and network 18. The network hosting the platform 20 provides additional computing resources to the client devices 14A-C and/or client network 12. For example, by utilizing the network hosting the platform 20, users of client devices 14A-C are able to build and execute applications for various enterprise, IT, and/or other organization-related functions. In one embodiment, the network hosting the platform 20 is implemented on one or more data centers 22, where each data center could correspond to a different geographic location. Each of the data centers 22 includes a plurality of virtual servers 24 (also referred to herein as application nodes, application servers, virtual server instances, application instances, or application server instances), where each virtual server can be implemented on a physical computing system, such as a single electronic computing device (e.g., a single physical hardware server) or across multiple-computing devices (e.g., multiple physical hardware servers). Examples of virtual servers 24 include, but are not limited to a web server (e.g., a unitary Apache installation), an application server (e.g., unitary Java® Virtual Machine), and/or a database server, e.g., a unitary MySQL® catalog (MySQL® is a registered trademark owned by MySQL AB A COMPANY).

To utilize computing resources within the platform 20, network operators may choose to configure the data centers 22 using a variety of computing infrastructures. In one embodiment, one or more of the data centers 22 are configured using a multi-tenant cloud architecture, such that one of the server instances 24 handles requests and serves multiple customers. Data centers with multi-tenant cloud architecture commingle and store data from multiple customers, where multiple customer instances are assigned to one of the virtual servers 24. In a multi-tenant cloud architecture, the particular virtual server 24 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure to a particular one of the server instances 24 causing outages for all customers allocated to the particular server instance

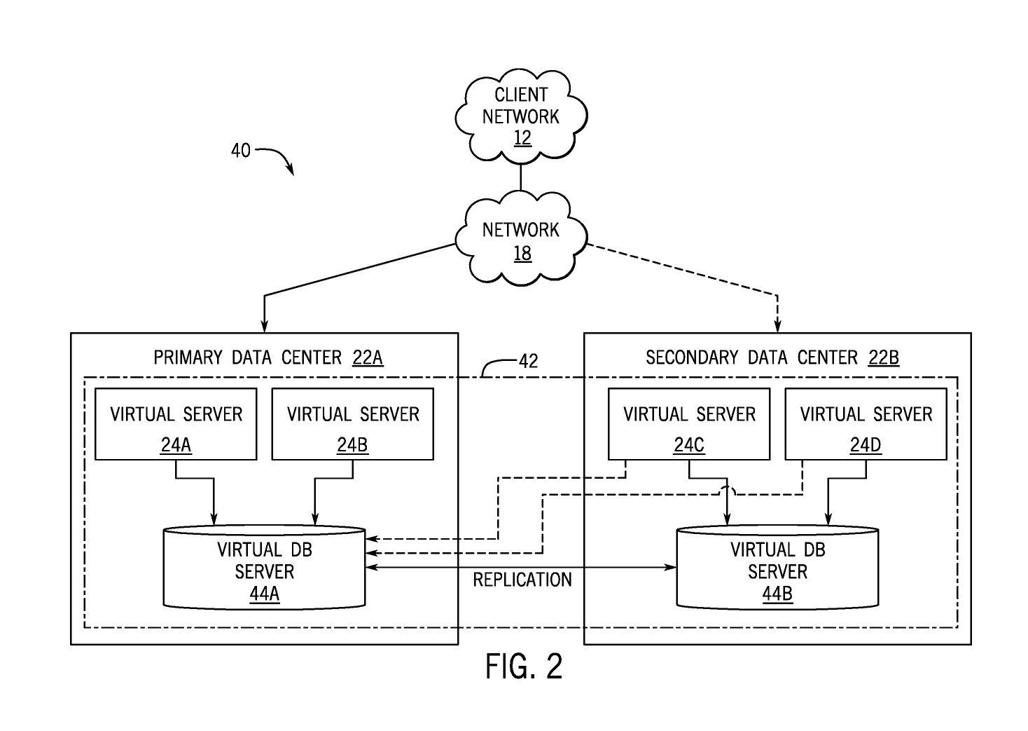

In another embodiment, one or more of the data centers 22 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server and/or other combinations of physical and/or virtual servers 24, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 20, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 40 where embodiments of the present disclosure may operate. FIG. 2 illustrates that the multi-instance cloud architecture 40 includes the client network 12 and the network 18 that connect to two (e.g., paired) data centers 22A and 22B that may be geographically separated from one another. Using FIG. 2 as an example, network environment and service provider cloud infrastructure client instance 42 (also referred to herein as a simply client instance 42) is associated with (e.g., supported and enabled by) dedicated virtual servers (e.g., virtual servers 24A, 24B, 24C, and 24D) and dedicated database servers (e.g., virtual database servers 44A and 44B). Stated another way, the virtual servers 24A-24D and virtual database servers 44A and 44B are not shared with other client instances but are specific to the respective client instance 42. Other embodiments of the multi-instance cloud architecture 40 could include other types of dedicated virtual servers, such as a web server. For example, the client instance 42 could be associated with (e.g., supported and enabled by) the dedicated virtual servers 24A-24D, dedicated virtual database servers 44A and 44B, and additional dedicated virtual web servers (not shown in FIG. 2).

In the depicted example, to facilitate availability of the client instance 42, the virtual servers 24A-24D and virtual database servers 44A and 44B are allocated to two different data centers 22A and 22B, where one of the data centers 22 acts as a backup data center. In reference to FIG. 2, data center 22A acts as a primary data center 22A that includes a primary pair of virtual servers 24A and 24B and the primary virtual database server 44A associated with the client instance 42, and data center 22B acts as a secondary data center 22B to back up the primary data center 22A for the client instance 42. To back up the primary data center 22A for the client instance 42, the secondary data center 22 includes a secondary pair of virtual servers 24C and 24D and a secondary virtual database server 44B. The primary virtual database server 44A is able to replicate data to the secondary virtual database server 44B.

As shown in FIG. 2, the primary virtual database server 44A may replicate data to the secondary virtual database server 44B using, e.g., a Master-Master My SQL Binlog replication operation. The replication of data between data could be implemented by performing full backups weekly and daily incremental backups in both data centers 22A and 22B. Having both a primary data center 22A and secondary data center 22B allows data traffic that typically travels to the primary data center 22A for the client instance 42 to be diverted to the second data center 22B during a failure and/or maintenance scenario. Using FIG. 2 as an example, if the virtual servers 24A and 24B and/or primary virtual database server 44A fails and/or is under maintenance, data traffic for client instances 42 can be diverted to the secondary virtual servers 24C and the secondary virtual database server instance 44B for processing.

Although FIGS. 1 and 2 illustrate specific embodiments of a cloud computing system 10 and a multi-instance cloud architecture 40, respectively, the disclosure is not limited to the specific embodiments illustrated in FIGS. 1 and 2. For instance, although FIG. 1 illustrates that the platform 20 is implemented using data centers, other embodiments of the platform 20 are not limited to data centers and can utilize other types of remote network infrastructures. Moreover, other embodiments of the present disclosure may combine one or more different virtual server into a single virtual server or, conversely, perform operations attributed to a single virtual server to multiple virtual servers. For instance, using FIG. 2 as an example, the virtual servers 24A-D and virtual database servers 44A and 44B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

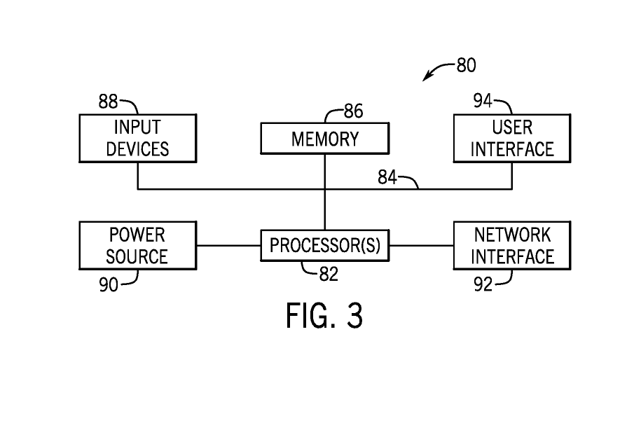

With this in mind, and by way of background, it may be appreciated that the present approach may be implemented using one or more processor-based systems such as shown in FIG. 3. Likewise, applications and/or databases utilized in the present approach stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 80 and their potential interconnections or communication paths, such as along one or more busses. As illustrated, the computing system 80 may include various hardware components such as, but not limited to, one or more processors 82, one or more busses 84, memory 86, input devices 88, a power source 90, a network interface 92, a user interface 94, and/or other computer components useful in performing the functions described herein.

The one or more processors 82 may include one or more microprocessors capable of performing instructions stored in the memory 86. Additionally or alternatively, the one or more processors 82 may include application-specific integrated circuits (ASICs), field-programmable gate arrays (FPGAs), and/or other devices designed to perform some or all of the functions discussed herein without calling instructions from the memory 86.

With respect to other components, the one or more busses 84 includes suitable electrical channels to provide data and/or power between the various components of the computing system 80. The memory 86 may include any tangible, non-transitory, and computer-readable storage media. Although shown as a single block in FIG. 1, the memory 86 can be implemented using multiple physical units of the same or different types in one or more physical locations. The input devices 88 correspond to structures to input data and/or commands to the one or more processor 82. For example, the input devices 88 may include a mouse, touchpad, touchscreen, keyboard and the like. The power source 90 can be any suitable source for power of the various components of the computing device 80, such as line power and/or a battery source. The network interface 92 includes one or more transceivers capable of communicating with other devices over one or more networks (e.g., a communication channel). The network interface 92 may provide a wired network interface or a wireless network interface. A user interface 94 may include a display that is configured to display text or images transferred to it from the one or more processors 82. In addition and/or alternative to the display, the user interface 94 may include other devices for interfacing with a user, such as lights (e.g., LEDs), speakers, and the like.

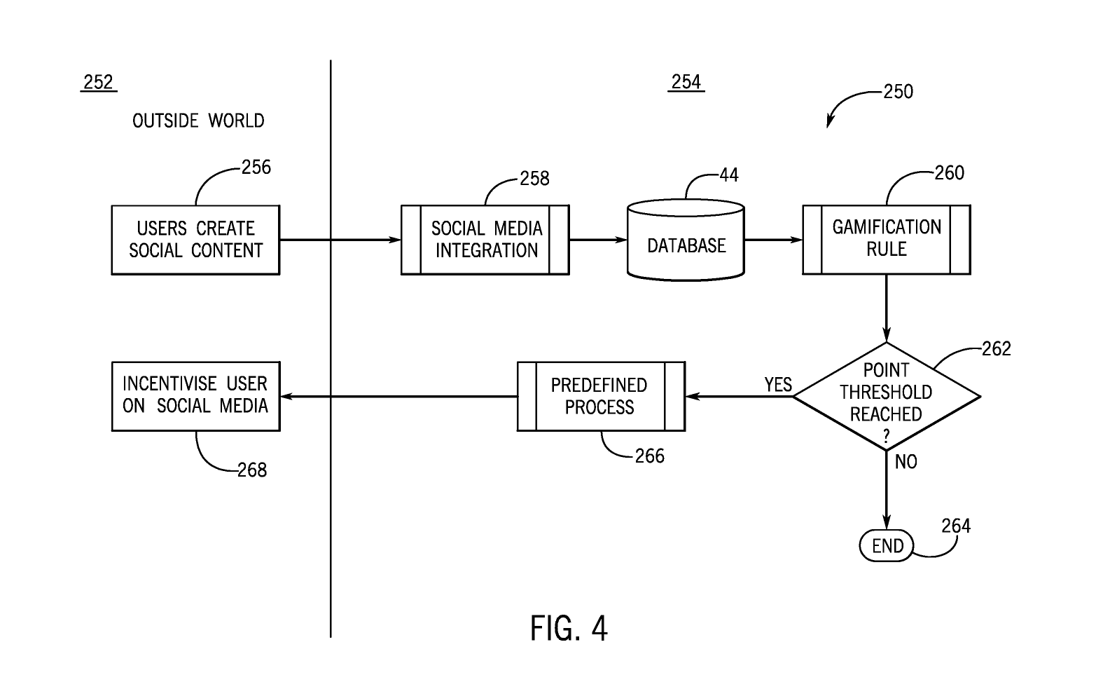

With the preceding in mind, and as discussed herein, systems, architectures, and frameworks such as those discussed above may be utilized by an organization that monitors and/or evaluates feedback on social media platforms related to the organizations products, which may include goods or services. Turning to FIG. 4, this figure is a block diagram 250 of an implementation of a system to incentivize social media users to continue to provide feedback regarding the organization's products. The block diagram 250 interrelates actions made externally (reference number 252) (i.e., in the outside world) and actions made internally (reference number 254) to the platform, such as via the platform 104. In the depicted example, at block 256, in the external environment a user of a social media platform generates or creates social media content. For example, the social media user may create social media content on social channels, such as social media platforms. As used herein, social media platforms are applications or web sites that enable a user community to exchange content and information (e.g., posts, pictures, etc.) to groups of people of community. Some popular social media platforms include FACEBOOK®, TWITTER®, and INSTAGRAM®.

Users of the social media platform may create social media content using a social media profile that the user controls and manages. An individual user may manage multiple social media profiles, which may be on the same or different social media platforms. In some embodiments, certain social media profiles are linked to one another. That is, creating social media content using a first social media profile would subsequently create substantially the same social media content on a second social media profile. The linked social media profiles may be on the same or different social media platforms. In some embodiments, the social media content is made privately or semi-privately. That is, the social media content is only viewable to certain other users, such as to associated social media profiles (e.g., “friends” or “followers”) or to certain social media profiles as determined by the user. In additional or alternative embodiments, the social media content is made publicly and is thus viewable to any other users. It may be appreciated that both public and private social media content may be made by the same social media profile.

At block 258, within the platform, the social media content from the outside world 252 is aggregated for evaluation. Such aggregation may be performed by one or more dedicated routines or modules that “scrape” one or more social media platforms for all content (e.g., posts) meetings certain criteria, such as containing the name of a product being monitored. For example, information associated with the social media content and meeting the aggregation criteria is extracted and saved within the platform, such as on a database 44. The saved information may therefore contain the contents of various posts on various social media platforms that meet the criteria for aggregation. For example, social media content may be filtered such that only social media content associated with monitored products is aggregated and stored. As a result of the filtering, instead of integrating all social media content, only relevant social media content is integrated into the platform.

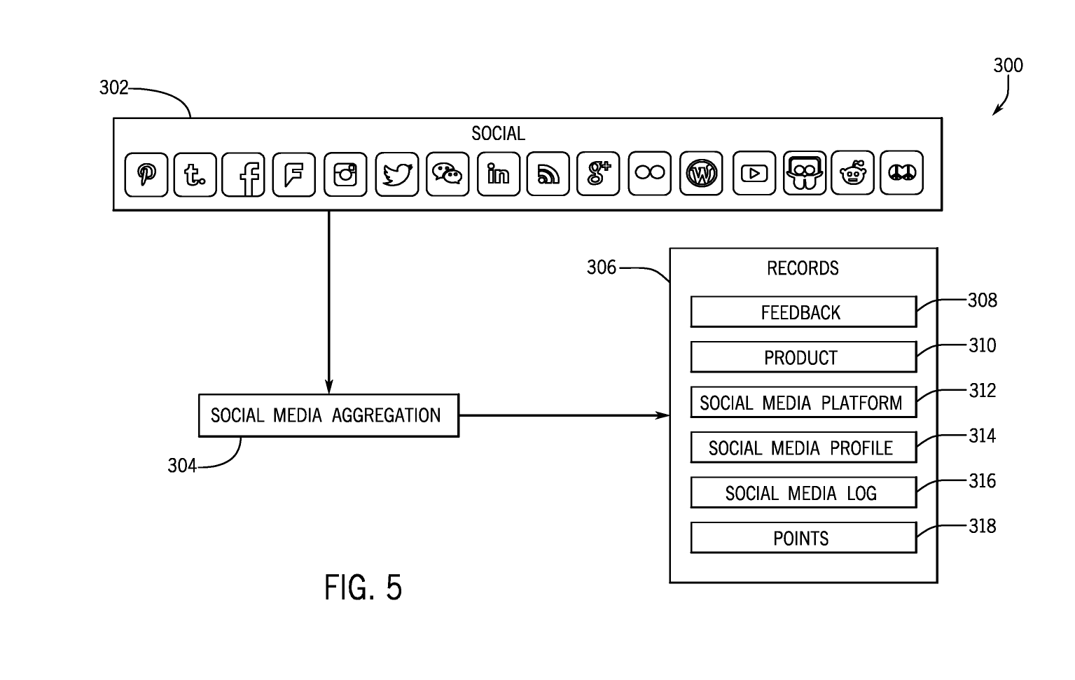

To further describe aspects of blocks 256 and 258 in one implementation, FIG. 5 is a block diagram 300 illustrating how social media content 302 may be integrated into the platform for evaluation. As illustrated in FIG. 5, social media content 302 is collected from multiple social media platforms via a social media aggregator 304, which may be implemented as one or more routines or modules executing on the platform. The social media aggregator 304 may determine relevant social media content 302 to be aggregated based on the information within the social media content 302. In some embodiments, relevant social media content 302 is that content that references or mentions a monitored product, including potentially providing, with feedback regarding the product. Once the social media content 302 is determined to be relevant, information associated with the social media content 302 is saved into records 306, which may be stored in the database 44 on the platform. For example, information may relate to feedback 308 within the content, the discussed product 310, a social media platform 312 where the social media content 302 was created, a social media profile 314 that created the social media content 302, a social media log 316 of previous social media content 302 created by the social media profile 314, and an associated amount of points 318 as determined based on the previously listed information and as discussed in greater detail below. As mentioned, the information saved within the records 306 may be used to evaluate the associated social media content 302 or to query for additional social media content. As an example, the social media log 316 of the corresponding social media profile 314 may be analyzed to determine if previous social media content 302 created by the social media profile 314 is associated with the product 310. In this manner, points 318 that were previously allocated for a respective post may be blocked from being continuously allocated if the same social media profile 314 attempts to provide feedback 308 associated with the same product 310 multiple times.

The records 306 may also be used to keep track of information related to users of social media. For example, the records 306 may assign the points 318 to the corresponding social media profile 314. As the social media profile 314 creates additional social media content 302, information associated with the points 318 updates accordingly. It may be appreciated that other information, such as feedback 308 and products 310, may also be assigned to the corresponding social media profile 314. In this manner, such information saved in the records 306 may be queried to refer to the corresponding social media profiles 314.

In some embodiments, social media profiles 314 of different social media platforms 312 are created separately, even if they are managed by a common user. That is, if a user creates social media content 302 using a first social media profile 314 on a first social media platform 312, then subsequently creates social media content 302 using a second social media profile 314 on a second social media platform 312, the records 306 may assign a first set of information to the first social media profile 314 and a second set of information to the second social media profile 314, as it may not be readily apparent that a single user is associated with both profiles. In additional or in alternative embodiments, social media profiles 314 of different social media platforms may be consolidated if they are managed by a common user and this can be readily determined. That is, social media content 302 created by a user via a first social media profile 314 on a first social media platform 312 and social media content 302 created by the user via a second social media profile 314 on a second social media platform 312 may be consolidated as if both social media contents 302 were created by a single social media profile 314.

The social media profile 314 may also include social media information such as contact information and/or other associated profiles (e.g., “friends,” “followers”) of the social media profile 322. In some embodiments, social media content 302 made by the same user results in different social media profiles 314 if made via different social media platforms 320. In additional or alternative embodiments, social media content 302 made via different social media platforms 320 may be analyzed to determine if the social media content 302 was made by the same user to prevent creating multiple social media profiles 314 for the same user. Thus, each relevant social media content 302 identified by the aggregator generates a corresponding internal record 306. The records 306 continues to update accordingly as additional social media content 302 is created.

Returning to FIG. 4, and with respect to the points 318 discussed above, after information regarding the social media content 302 has been saved into the database 44, gamification rules are applied (block 260) to determine an amount of points 318, if any, to associate with a respective the social media record (e.g., post). In some embodiments, the gamification rules are evaluation rules that award a certain amount of points 318 based on information associated with the social media content 302 or other criteria as discussed herein. The points may be based on any information in the records 306. As an example, points 318 may be awarded based on the product mentioned in the social media content 302, based on a key word or other evaluation of the content of the feedback (e.g., more points awarded for more favorable feedback), based on the popularity of the social media platform on which the feedback was left, based on a number of friends or followers associated with the social media profile leaving the feedback, or based on a posting history associated with the social media profile.

After applying the rules, the points 318 are allocated to the corresponding user, such as via updating the records 306. The records 306 are then analyzed to determine if a point threshold has been reached (block 262). If the point threshold is determined not to have been reached, no further action is needed (block 264).

If the points threshold is met or exceeded, a reward process is performed (block 266). The reward process may be performed to further incentivize the individual associated with the respective social media profile. In some embodiments, the reward process is intended to incentivize the user (or friends or followers of the profile) to leave additional feedback, to continue use of the product, to try new and/or related products, to encourage other to try the product, and so forth. The reward process may include rules similar to the gamification rules of block 260 to determine the type and/or extent of reward to provide the user associated with the social media platform. As such, the reward process may also use information associated with the social media content 302, such as to provide rewards based on an evaluation of the content of the feedback (e.g., more points awarded for more favorable feedback), based on the popularity of the social media platform, based on a number of friends or followers associated with the social media profile leaving the feedback, and so forth.

After the reward process is performed, the user may be incentivized via social media (block 268), such as via the same social media platform on which the feedback was posted. For example, an acknowledgement or comment may be posted on the social media platform to the user's profile or account. In higher reward scenarios, a redeemable code or coupon may be posted, an offer for new or additional products or services may be provided, and so forth. In this manner, the user is encouraged to continue providing additional feedback in hopes of receiving additional rewards. The additional feedback may serve to promote or publicize the product or other products.

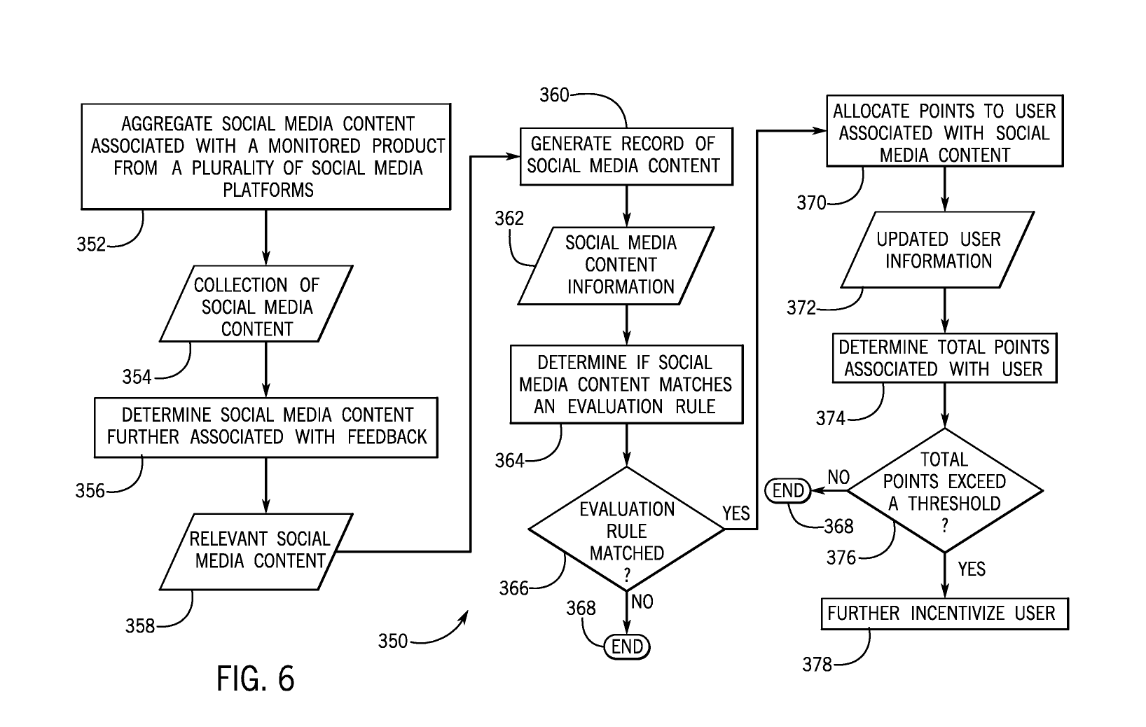

To illustrate one implementation of the process of the block diagram 250 in greater detail, FIG. 6 is a flowchart illustrating a method 350 to incentivize providing feedback via social media platforms. At block 352, social media content 302 from a plurality of social media platforms are filtered to determine if the social media content 302 are associated with a monitored product. The filtered social media content 302 is then aggregated. In some embodiments, the social media content 302 may be analyzed to determine if the social media content 302 include words related to a product or an organization associated with the product (e.g., manufactures, sells, and/or delivers the product). For example, the social media content 302 associated with a certain product may include descriptions of the product, such as features of the product and/or specifications of the product, which includes commonly appearing words. Such words may be determined through methods such as machine learning to assign as keywords when aggregating the social media content 302. To aggregate the social media content 302, methods as described in block 258 and FIG. 4 may be used. As a result, a collection of social media content 354 is created.

The collection of social media content 354 may be analyzed to determine if one or more posts or other discrete units of the social media content 302 within the collection of social media content 354 is further associated with feedback of the monitored product (block 356). In some embodiments, social media content 302 may be analyzed by detecting keywords within the social media content 302 that may be indicative of product feedback. For example, the user's sentiment may be quantitative (e.g., a numerical rating or scale), qualitative (e.g., with descriptions and/or explanations), or any combination thereof. Thus, the social media content 302 may be analyzed to determine if the social media content 302 includes words related to feedback (e.g., descriptive words or numbers that may be related to quantitative ratings). As a result, a relevant social media content 358 is determined. Specifically, the relevant social media content 358 includes feedback associated with a monitored product.

After a relevant social media content 358 has been determined, records of the relevant social media content 358 are generated (block 360). In some embodiments, the records are generated via the methods described in block 258 and in FIG. 4 to be saved within the database 44. In some embodiments, the records may additionally or alternatively be saved elsewhere, such as on one or more other logical or physical storage structures. The records may include information related to the feedback 308, the product 310, the social media platform 312, the social media profile 314, the social media log 316, and the points 318. The generated records are then used as social media content information 362 that can be referred to.

At block 364, using the social media content information 362, the relevant social media content 358 is evaluated with one or more evaluation rules. In some embodiments, the relevant social media content 358 is analyzed for content (e.g., keywords, phrases) to determine if a respective evaluation rule applies. For example, the relevant social media content 358 may be analyzed to determine if the feedback is positive, negative, mixed, or any combination thereof. Additionally, the relevant social media content 358 is analyzed to determine a degree of the sentiment within the relevant social media content 358, such as how positive or negative the feedback is. It should be appreciated that the evaluation rules may be created internally, such as by an administrator of the platform 104. That is, the administrator may assign the evaluation rules' conditions to be satisfied in order for a successful match of the relevant social media content 358 with the evaluation rule.

A series of relevant evaluation rules may be analyzed to determine if any evaluation rules match (block 366). If no evaluation rules match, then the method 350 ends and no further actions are performed (block 368). However, in some embodiments, the social media content information 362 remains within the database 44. If at least one evaluation rule match, then a point value is allocated to the user that created the relevant social media content 358 based at least in part on the evaluation rule (block 370). In some embodiments, the sentiment of the feedback and/or the degree of the sentiment of the feedback determines the associated point value. That is, positive feedback, negative feedback, and/or mixed feedback may result in different point values. Additionally, the degree of how positive and/or how negative the feedback content entails may result in different point values. To determine the sentiment of the feedback, machine learning and/or sentiment analysis tools may be implemented to analyze the content of the feedback.

Additionally, the point value may be based on the product mentioned in the relevant social media content 358. For example, since newer products may be more difficult to publicize due to lack of exposure in a market, providing feedback on a newer product may result in a higher number of points and a corresponding higher incentive to mention the new product. Other criteria that may change the determined point values include the number of associated profiles (e.g., more points for more “friends” or “followers”) of the user, visibility of the relevant social media content 358 (e.g., public, private, semi-private), actions performed as a result of the relevant social media content 358 (e.g., views, comments), or any combination thereof.

After allocating the points appropriately, the records includes updated user information 372. The total points associated with the user is then determined (block 374). It should be appreciated that the user may have previously created social media content 302 that have matched with one or more evaluation rules to allocate points to the user. As such, the user information may include an accumulation of points. The total points is then compared to a predetermined threshold to determine if the threshold has been exceeded (block 376). In some embodiments, the predetermined threshold may be set such that every relevant social media content 358, so long as the relevant social media content 358 matches with at least one evaluation rule, would result in exceeding a reward threshold. In alternative embodiments, the predetermined threshold may be set such that a user creates multiple relevant social media content 358, each matching with at least one evaluation rule and allocating similar or different point values to the user, to exceed the threshold. Furthermore, a combination of the aforementioned predetermined thresholds may be implemented. As discussed above, in some embodiments, relevant social media content 358 created by the user in profiles of different social media platforms may result in an allocation of points separately to each corresponding profile. However, in alternative embodiments, relevant social media content 358 created by the user in profiles of different social media platforms may result in a single allocation of points by combining the points allocated to each corresponding profile.

If the user's total points have been determined to be below the threshold, the method 350 ends and no further actions are performed (block 368). If the user's total points have been determined to exceed the threshold, the user is further incentivized (block 378) by providing a reward or other incentive. Methods as described in block 266 to determine how to incentivize the user may be implemented. In some embodiments, the user is incentivized by being given a discount applied to the same product or a different product that may be of interest to the user. Alternatively, the user may be given sample products, store credit, exclusive news, or another suitable incentive. It should also be appreciated that any combination of incentives is also possible and that the incentive may be based at least in part on the social media content information 362. For example, exceeding a threshold that includes a higher number of points may result in a reward worth more monetarily.

Furthermore, in some embodiments, the user is reached out to via the social media platform associated with the user's relevant social media content 358. The method to reach out to the user may also be based at least in part on the social media content information 362. For example, the methods may include a private message, a public posting, or any combination thereof. A private message may further incentivize the social user specifically, though the user may also distribute incentive information to associated users and profiles. Contrarily, a public posting may be viewed by several users and profiles without having to be initially distributed by the social media user. In either case, others may be influenced to also participate in providing feedback to obtain incentives.

As discussed herein, this disclosure generally relates to aggregating social media content that relate to monitored products. The social media content may be made from different user profiles of different social media platforms. The aggregated social media content is then analyzed to determine if any of the social media content is associated with feedback of the monitored products. Such social media content are then matched with evaluation rules to determine corresponding point values, which are allocated to the respective user profiles. As a user profile continues to provide feedback, the user profile accumulates points. When the points associated with the user profile has exceeded a threshold, the user profile may be further incentivized, such as via rewards, to provide feedback. Such incentives may also be made such that other user profiles are aware of the rewards and thus, may also be influenced to provide feedback via social media.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system, comprising:
a virtual or physical server system comprising a social media aggregator, wherein the server system is configured to execute routines which, when executed, cause operations to be performed comprising:
identifying social media content on one or more social media platforms, wherein the social media content is associated with a user profile and provides feedback related to a monitored product;
applying one or more evaluation rules to the social media content to allocate points to the user profile based on the feedback; and
in response to the user profile reaching a threshold quantity of points, providing an incentive to the user profile via the social media platform.

2. The system of claim 1, wherein the virtual or physical server system is part of a datacenter hosting a multi-instance architecture.

3. The system of claim 1, wherein identifying the social media content comprises detecting keywords within the social media content, wherein the keywords are indicative of the feedback related to the monitored product.

4. The system of claim 1, wherein the one or more evaluation rules are based on one or more of the monitored product, a keyword in the feedback, evaluation content of the feedback, the social media platform on which the feedback was posted, a number of friends associated with the user profile leaving the feedback, a number of followers associated with the user profile leaving the feedback, or a posting history associated with the user profile.

5. The system of claim 1, further comprising a database configured to store records generated in based on the identified social media content.

6. The system of claim 5, wherein the records comprise one or more of the feedback, the monitored product, a respective social media platform on which the social media content was identified, a user profile that created the identified social media content, a social media log of previous social media content created by the user profile, and points associated with the user profile.

7. The system of claim 5, wherein the routines, when executed by the server system, cause operations to be performed further comprising generating or updating the records stored on the database as social media content is identified.

8. The system of claim 7, wherein the incentive comprises one or more of an acknowledgement or comment posted on the social media platform to the user profile, a redeemable code or coupon, or an offer for new or additional products or services.

9. A system, comprising:
one or more databases configured to store records generated from social media content related to a monitored product; and
one or more processor-based devices in communication with the one or more databases, wherein the processor-based devices are configured to execute computer-executable instructions stored on tangible media, wherein the instructions, when executed, cause the one or more processors to:
aggregate social media data comprising feedback associated with the monitored product;
generate records stored on the one or more databases, wherein each record is associated with one or both of a respective social media posting or user profile associated with the aggregated social media data;
evaluate the records stored on the one or more databases using one or more rules, wherein the one or more rules award points to respective user profiles based at least on the respective feedback regarding the monitored product; and
post a message to a social media account associated with the user profile when a number of points associated with the user profile exceeds one or more thresholds.

10. The system of claim 9, wherein the one or more databases comprise virtual database servers accessible via a client instance.

11. The system of claim 9, wherein the one or more processor-based devices comprise virtual servers accessible via a client instance.

12. The system of claim 9, wherein the one or more rules are based on one or more of the monitored product, content of the feedback, a social media platform on which the social media data was posted, a number of friends associated with the user profile posting the social media data, a number of followers associated with the user profile posting the social media data, or a posting history associated with the user profile.

13. The system of claim 9, wherein the message comprises one or more of an acknowledgement or comment posted on the social media platform to the user profile, a redeemable code or coupon, or an offer for new or additional products or services.

14. A method to promote product feedback, comprising:
identifying social media content on a social media platform, wherein the social media content is associated with a user profile and provides feedback related to a monitored product;
applying one or more evaluation rules to the social media content to allocate points to the user profile based on the feedback; and
in response to the user profile reaching a threshold quantity of points, providing an incentive to the user profile via the social media platform.

15. The method of claim 14, wherein identifying the social media content comprises detecting keywords within the social media content, wherein the keywords are indicative of the feedback related to the monitored product.

16. The method of claim 15, comprising saving information associated with the social media content in response to identifying the social media content, wherein the information is associated with the user profile, the feedback, the monitored product, the social media platform, the social media content, or any combination thereof.

17. The method of claim 16, comprising updating the saved information in response to applying the one or more evaluation rules to the social media content.

18. The method of claim 14, wherein providing an incentive to the user profile comprises providing one or more of a discount to the product, providing a discount to an additional product, providing a sample product, providing store credit, or any combination thereof.

19. The method of claim 14, wherein applying one or more evaluation rules comprises determining a sentiment of the feedback, a degree of the sentiment of the feedback, or any combination thereof.

20. The method of claim 19, wherein applying one or more evaluation rules is performed via machine learning, sentiment analysis tools, or any combination thereof.
